(19) United States
(12) Patent Application Publication
(10) Pub. No.: US 2019/0316558 A1
(43) Pub. Date: Oct. 17, 2019

(54) High-Pressure Fuel Supply Pump

(71) Applicant: Hitachi Automotive Systems, Ltd., Hitachinaka-shi, Ibaraki (JP)

(72) Inventors: Masahiko HAYATANI, Hitachinaka-shi, Ibaraki (JP); Kenichiro TOKUO, Hitachinaka-shi, Ibaraki (JP); Yuta SASO, Hitachinaka-shi, Ibaraki (JP); Satoshi USUI, Hitachinaka-shi, Ibaraki (JP); Katsutoshi KOBAYASHI, Tokyo (JP)

(21) Appl. No.: 16/316,817

(22) PCT Filed: Jun. 20, 2017
(86) PCT No.: PCT/JP2017/022610

§ 371 Date: Jan. 10, 2019

(30) Foreign Application Priority Data
Jul. 13, 2016 (JP) 2016-138120

(51) Int. Cl. F02M 59/46; F02M 63/00

(52) U.S. Cl. CPC F02M 59/466; F02M 59/366; F02M 63/005

(57) ABSTRACT

An object of the present invention is to provide a high-pressure fuel supply pump that can restrict lowering of pressure and generation of cavitation in the vicinity of a seat by providing a throttle in a relief spring holder. Accordingly, in order to achieve the above object, the present invention relates to a fuel supply pump that includes a pressurizing chamber configured to pressurize fuel, and a relief valve mechanism configured to return fuel in a discharge path on a downstream side of the discharge valve to the pressurizing chamber. The relief valve mechanism includes a relief seat configured to close a relief channel when a relief valve is seated, a relief spring configured to energize the relief valve to the relief seat, and a relief spring holder configured to hold the relief spring. In the relief spring holder, a throttle section is formed in a fuel path for returning from a relief chamber in which the relief spring is disposed to the pressurizing chamber and the channel. The above object can be achieved by the above configuration.

### TECHNICAL FIELD

The present invention relates to a structure of a high-pressure fuel supply pump, and in particular, to a relief valve structure.

### BACKGROUND ART

High-pressure fuel supply pumps are widely used for pressurizing fuel in cylinder-injection internal combustion engines that directly inject fuel into a combustion chamber. As a background art of such high-pressure fuel pumps, JP 2009-114868 A discloses a relief valve that is configured to have a throttle effect (an effect of increasing a flow rate by throttling flow of a fluid in order to generate a pressure lower than that at a low-rate section) at a gap between a housing and a valve element presser in a fuel path in which a fluid flows from a high-pressure side to a low-pressure side of a high-pressure fuel supply pump. By the above configuration, the relief valve can be moved significantly to a valve opening direction by a pressure difference generated between the high-pressure side and the low-pressure side of the valve element presser, and a pressure in a high-pressure pipe can be lowered promptly.

### CITATION LIST

### Patent Literature

PTL 1: JP 2009-114868 A

### SUMMARY OF INVENTION

### Technical Problem

However, when a relief valve mechanism including the technique of PTL 1 is applied to a high-pressure fuel supply pump having a structure of returning a fluid to a pressurizing chamber (high pressure side), a flow of fuel sucked into the pressurizing chamber from a relief valve is generated in an intake process (when a plunger moves down) at the time of normal operation of the high-pressure fuel supply pump. When a flow rate is increased at a gap section between a housing and a valve element presser having a small gap and a relief valve seat section in the vicinity of the gap section, and a pressure at the gap section is lowered, leading to generation of cavitation and damage to the seat section by erosion. As a result, a fuel sealing function of the relief valve seat may be impaired.

In view of the above, an object of the present invention is to provide a high-pressure fuel supply pump that can restrict lowering of a pressure and generation of cavitation in the vicinity of a seat by providing a throttle in a relief spring holder.

### Solution to Problem

In order to achieve the above object, the present invention relates to a fuel supply pump that includes a pressurizing chamber configured to pressurize fuel, and a relief valve mechanism configured to return fuel in a discharge path on a downstream side of the discharge valve to the pressurizing chamber. The relief valve mechanism includes a relief seat configured to close a relief channel when a relief valve is seated, a relief spring configured to energize the relief valve to the relief seat, and a relief spring holder configured to hold the relief spring. In the relief spring holder, a throttle section is formed in a fuel path for returning from a relief chamber in which the relief spring is disposed to the pressurizing chamber and the channel.

### Advantageous Effects of Invention

According to the present invention configured as described above, cavitation erosion can be prevented in a relief valve mechanism, and reliability of a high-pressure fuel supply pump can be improved.

### BRIEF DESCRIPTION OF DRAWINGS

FIG. 1 is an entire longitudinal cross-sectional view of a high-pressure fuel supply pump according to a first embodiment in which the present invention is implemented.

FIG. 2 is a cross-sectional view showing the high-pressure fuel supply pump according to the first embodiment viewed from a different angle.

FIG. 3 is a cross-sectional view of an axial center of an intake opening of fuel and an axial center of a discharge opening perpendicular to a plunger axial direction of the high-pressure fuel supply pump according to the first embodiment.

FIG. 4 is an entire system diagram including the high-pressure fuel supply pump.

FIG. 5 is a cross-sectional view of a relief valve mechanism according to a first embodiment in which the present invention is implemented.

FIG. 6 is a schematic diagram showing flow of fuel during an intake process (when a plunger moves down) at the time of normal operation of the high-pressure fuel supply pump according to the first embodiment in which the present invention is implemented.

FIG. 7 is a schematic diagram showing flow of fuel at the time of normal operation of a high-pressure fuel supply pump according to a second embodiment.

### DESCRIPTION OF EMBODIMENTS

Hereinafter, embodiments according to the present invention will be described.

### First Embodiment

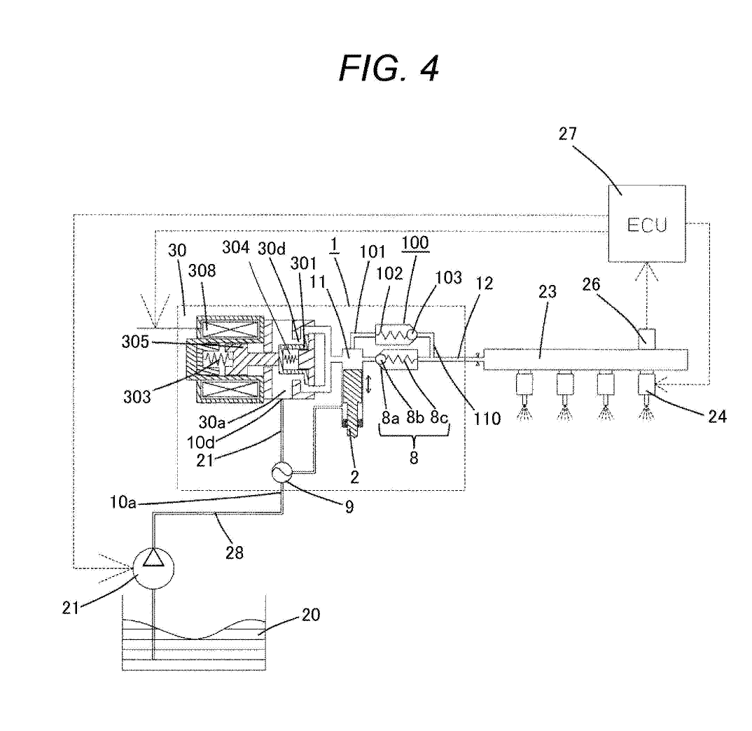

Hereinafter, a first embodiment according to the present invention will be described with reference to the accompanying drawings. First, a configuration and operation of a system will be described with reference to FIG. 4. FIG. 4 is a diagram showing an entire configuration of the system including a high-pressure fuel supply pump according to the present invention.

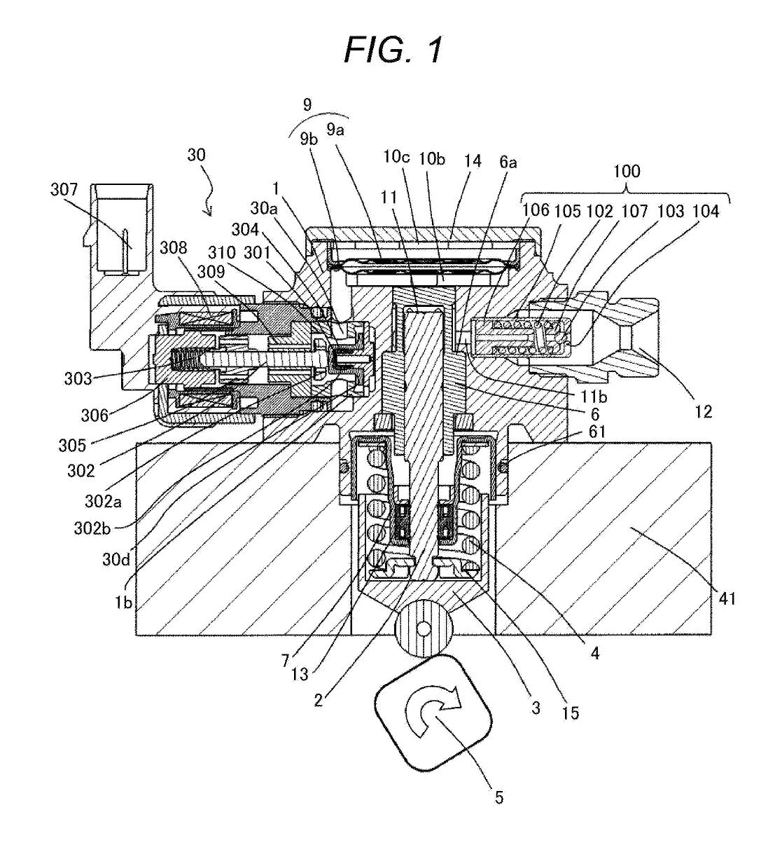

A section enclosed by a broken line shows a main body 1A of a high-pressure fuel supply pump (hereinafter referred to as high-pressure pump) 1 (refer to FIG. 1), and a mechanism and a component shown in the broken line are incorporated integrally in the high-pressure pump main body 1A.

Fuel of a fuel tank 20 is pumped up by a feed pump 21, and is sent to an intake joint 10a of the pump main body (pump body) 1A through an intake pipe 28. Fuel that has passed through the intake joint 10a reaches an intake port 30a of an electromagnetic intake valve 30 that constitutes a variable displacement mechanism through the pressure pulsation reduction mechanism 9, an intake path 10d. The pressure pulsation prevention mechanism 9 will be described later.

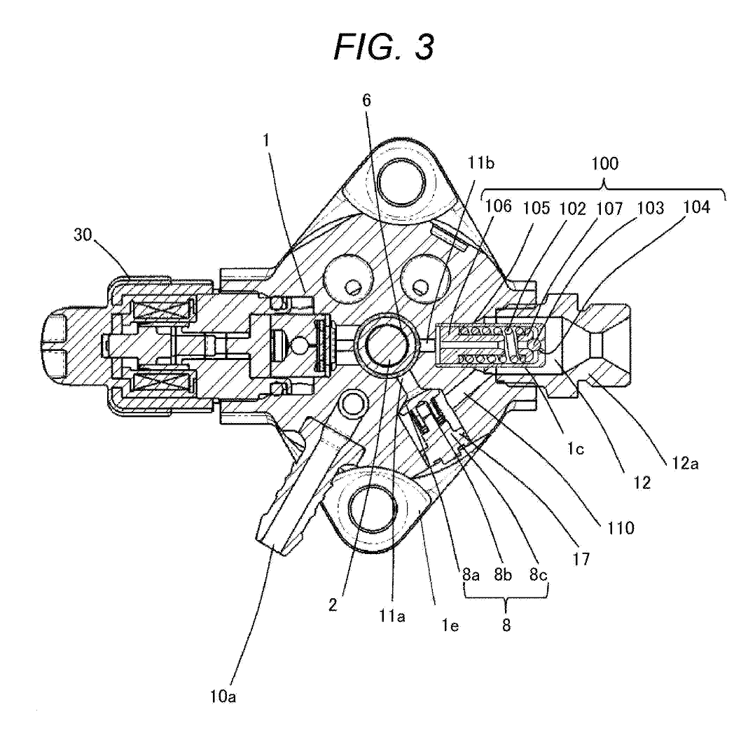

The electromagnetic intake valve 30 includes an electromagnetic coil 308. When the electromagnetic coil 308 is not electrified, an anchor (electromagnetic plunger) 305 and an intake valve element 301 are in a state of being moved to the right as shown in FIG. 3 by being energized by an energizing force that is a difference between an energizing force of an anchor spring 303 and an energizing force of a valve spring 304. At this time, the intake valve element 301 is energized in a valve opening direction, and an intake opening 30d is in an open state.

An energizing force of the anchor spring 303 is set to be larger than an energizing force of the valve spring 304.

On the other hand, in a state where the electromagnetic coil 308 is electrified, the anchor 305 is moved to the left in FIG. 4, and the anchor spring 303 is in a compressed state. The intake valve element 301, that is attached to a front end of the anchor 305 so as to be coaxially in contact with the front end of the anchor 305, closes the intake opening 30d by an energizing force of the valve spring 304. The intake opening 30d is a fuel path (fuel channel) that connects a pressurizing chamber 11 and the intake port 30a of the high-pressure pump 1.

Next, operation of the high-pressure pump 1 will be described. When a plunger 2 is displaced in a downward direction in FIG. 4 by rotation of a cam 5 described later and in a state of an intake process, a capacity of the pressurizing chamber 11 is increased and a fuel pressure in the pressurizing chamber 11 is lowered. When a fuel pressure in the pressurizing chamber 11 becomes lower than a pressure of the intake path 10d (the intake port 30a) in this process, fuel passes through the intake opening 30d in an open state to flow into the pressurizing chamber 11.

When the intake process is finished and transition is made to a compression process, the plunger 2 makes a transition to the compression process (a state of moving in an upward direction in FIG. 1). At this time, the electromagnetic coil 308 maintains a non-electrified state, and no magnetic energizing force acts on the anchor 305. Accordingly, the intake valve element 301 is kept opened by an energizing force of the anchor spring 303.

In the compression process, the capacity of the pressurizing chamber 11 is decreased in accordance with compression movement of the plunger 2. However, in this state, fuel once sucked into the pressurizing chamber 11 is returned to the intake path 10d (intake port 30a) again through the intake valve element 301 in an open state. For this reason, a pressure of the pressurizing chamber 11 never increases. This process will be referred to as a return process.

In this state, when a control signal from an engine control unit 27 (hereinafter referred to as ECU) is applied to the electromagnetic intake valve 30, an electric current flows through the electromagnetic coil 308 of the electromagnetic intake valve 30. At this time, a magnetic energizing force is applied to the anchor 305, and the anchor 305 moves to the left in FIG. 4 and the anchor spring 303 becomes in a compressed state. As a result, an energizing force of the anchor spring 303 does not act on the intake valve element 301, and an energizing force of the valve spring 304 and a fluid force caused by fuel flowing into the intake path 10d (intake port 30a) work. For this reason, the intake valve element 301 is closed, and the intake opening 30d is closed.

From at a time when the intake opening 30d is closed, a fuel pressure of the pressurizing chamber 11 increases together with a moving-up movement of the plunger 2. When the fuel pressure of the pressurizing chamber 11 becomes equal to or higher than a fuel pressure on the fuel discharge opening 12 side, fuel that remains in the pressurizing chamber 11 is discharged at high pressure through a discharge valve mechanism 8. The high-pressure fuel discharged to the discharge opening 12 side is supplied to a common rail 23. This process will be referred to as a discharge process.

That is, the compression process (a moving-up process from a lower starting point to an upper starting point) of the plunger 2 consists of the return process and the discharge process. By controlling a timing of electrifying the electromagnetic coil 308 of the electromagnetic intake valve 30, an amount of discharged high-pressure fuel can be controlled. When the timing of electrifying the electromagnetic coil 308 is made earlier, the proportion of the return process in the compression process becomes smaller, and the proportion of the discharge processing becomes larger. That is, an amount of fuel returned to the intake path 10d (intake port 30a) becomes smaller, and an amount of fuel that is discharged at high pressure becomes larger.

On the other hand, when the timing of electrifying the electromagnetic coil 308 is delayed, the proportion of the return process in the compression process becomes larger, and the proportion of the discharge processing becomes smaller. That is, an amount of fuel returned to the intake path 10d becomes larger, and an amount of fuel that is discharged at high pressure becomes smaller.

The timing of electrifying the electromagnetic coil 308 is controlled by an instruction from the ECU 27.

By controlling the timing of electrifying the electromagnetic coil 308 in the above configuration, an amount of fuel discharged at high pressure can be controlled to an amount required by an internal combustion engine.

The discharge valve mechanism 8 is provided at an exit of the pressurizing chamber 11. The discharge valve mechanism 8 includes a discharge valve seat surface (discharge valve seat section) 8a, a discharge valve 8b, and a discharge valve spring 8c. In a state where there is no fuel pressure difference between the pressurizing chamber 11 and the fuel discharge opening 12, the discharge valve 8b is pressed against the discharge valve seat surface 8a by an energizing force of the discharge valve spring 8c, and is in a closed state. It is not until a fuel pressure in the pressurizing chamber 11 becomes larger than a fuel pressure on a discharge joint side constituting the discharge opening 12 that the discharge valve 8b is opened against the discharge valve spring 8c. With the discharge valve 8b opened, fuel in the pressurizing chamber 11 is discharged at high pressure to the common rail 23 through the fuel discharge opening 12.

As described above, fuel guided to the intake joint 10a is pressurized to a high pressure by reciprocation of the plunger 2 in the pressurizing chamber 11 of the pump main body 1A, and a necessary amount of fuel is force-fed to the common rail 23 from the fuel discharge opening 12.

The common rail 23 is mounted with a direct injection injector 24 and a pressure sensor 26. The direct injection injector 24 is mounted in accordance with the number of cylinders of an internal combustion engine, and is opened or closed in accordance with a control signal from the engine control unit (ECU) 27 to inject fuel into a cylinder (combustion chamber) of an internal combustion engine.

The pump main body 1A is further provided with a relief valve mechanism 100. The relief valve mechanism 100 is provided with a relief path (return path) 101 that communicates a downstream side of the discharge valve 8b with the pressurizing chamber 11. The relief path 101 is provided separately from the discharge path 110 and bypasses the discharge valve mechanism 8. The relief path 101 is provided with a relief valve 103. The relief valve 103 limits flow of fuel to only one direction, from the discharge path 110 to the pressurizing chamber 11.

The relief valve 103 is pressed against the relief valve seat 104 by a relief spring 102 that generates a pressing force (energizing force). The relief valve 103 is set to be apart from the relief valve seat 104 and opened when a pressure difference between a fuel pressure in the pressurizing chamber and a fuel pressure in the discharge path 110 becomes a specified pressure or larger.

When an abnormally high pressure occurs in the common rail and the like due to a failure and the like of the direct injection injector 24, and a pressure difference between a fuel pressure of the discharge path 110 and a fuel pressure of the pressurizing chamber 11 becomes a valve opening pressure of the relief valve 103 or higher, the relief valve 103 is opened. When the relief valve 103 is opened, fuel of the common rail 23 at an abnormally high pressure is returned to the pressurizing chamber 11 from the relief path 101. In this manner, a high-pressure section pipe of the common rail 23 and the like is protected.

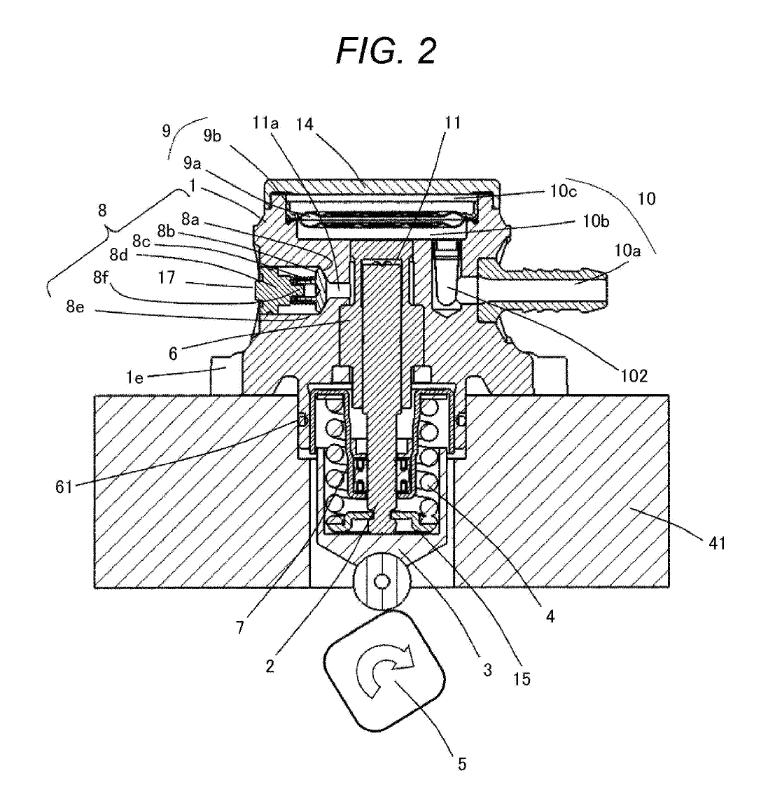

Next, a configuration and operation of a high-pressure fuel supply pump will be described more in detail with reference to FIGS. 1, 2, 3, and 4. FIG. 1 is an entire cross-sectional view showing the high-pressure fuel supply pump according to the first embodiment of the present invention cut in an axial direction of a plunger. FIG. 2 is an entire cross-sectional view of the high-pressure fuel supply pump according to the first embodiment of the present invention viewed from another angle, and is a cross-sectional view at an axial center of an intake joint. FIG. 3 is an entire cross-sectional view showing the high-pressure fuel supply pump according to the first embodiment of the present invention cut in a direction perpendicular to an axial direction of a plunger, and is a cross-sectional view at an axial center of an intake opening of fuel and at an axial center of a discharge opening.

In general, a high-pressure pump uses a flange 1e (refer to FIG. 3) provided in the pump main body 1A to be closely fixed to a flat surface of a cylinder head 41 of an internal combustion engine. To maintain airtightness between the cylinder head 41 and the pump main body 1A, an O-ring 61 is fitted to the pump main body 1A.

A cylinder 6 is attached to the pump main body 1A. The cylinder 6 guides forward and backward movement (reciprocation) of the plunger 2, and has an end portion formed in a tubular shape so as to internally form the pressurizing chamber 11. The pressurizing chamber 11 is also provided with a communication path 11a (refer to FIG. 3) so as to communicate with the electromagnetic intake valve 30 used for supplying fuel and the discharge valve mechanism 8 (refer to FIG. 3) used for discharging fuel to a discharge path from the pressurizing chamber 11. A tappet 3 that converts a rotation movement of the cam 5 attached to a cam shaft of an internal combustion engine to a vertical movement and transmits the movement to the plunger 2 is provided at a lower end of the plunger 2. The plunger 2 is pressed and joined with the tappet 3 by a spring 4 with a retainer 15 provided between them. In this manner, the plunger 2 can perform forward and backward (reciprocation) movement with rotational movement of the cam 5.

A plunger seal 13 (refer to FIG. 1) held in an inner peripheral lower end section of a seal holder 7 is installed in a lower end section in the diagram of the cylinder 6 in a state of being slidably in contact with an outer periphery of the plunger 2. In this manner, a blow-by gap between the plunger 2 and the cylinder 6 is sealed, which prevents fuel from leaking outside the pump. At the same time, a lubricant (including engine oil) that lubricates a sliding section in an internal combustion engine is prevented from flowing into the pump main body 1A through the blow-by gap.

Fuel pumped up by the feed pump 21 (refer to FIG. 4) is sent to the pump main body 1A through the intake joint 10a connected to the intake pipe 28. A damper cover 14 forms low-pressure fuel chambers 10b and 10c by being connected with the pump main body 1A, and fuel that has passed through the intake joint 10a flows into the low-pressure fuel chamber 10b and 10c. In an upstream side of the low-pressure fuel chambers 10b and 10c, a fuel filter 120 is attached by, for example, being press-fit to the pump main body 1A, so as to remove abnormal substances, such as metal powder contained in fuel. The intake joint 10a and the low-pressure fuel chambers 10b and 10c constitute a low-pressure fuel path section 10 through which low-pressure fuel flows.

The pressure pulsation reduction mechanism 9 is installed in the low-pressure fuel chambers 10b and 10c. The pressure pulsation reduction mechanism 9 reduces an influence that pressure pulsation generated in the high-pressure pump 1 has on the fuel pipe 28. When fuel that is once sucked in the pressurizing chamber 11 is returned to the intake path 10d (intake port 30a) through the intake valve element 301 in an open state for capacity control, the fuel that is returned to the intake path 10d (intake port 30a) generates pressure pulsation in the low-pressure fuel chambers 10b and 10c. However, this pressure pulsation is absorbed and reduced by the pressure pulsation reduction mechanism 9.

The pressure pulsation reduction mechanism 9 is formed by a metal damper 9a that has two disc metal plates having a corrugated shape laminated on an outer periphery of the metal damper 9a, and contains injected inert gas, such as argon. Pressure pulsation is absorbed and reduced as the metal damper 9a expands and contracts. An attaching metal fitting 9b is used for fixing the metal damper 9a to an inner peripheral section of the pump main body 1A.

The electromagnetic coil 308 of the electromagnetic intake valve 30 is connected to the ECU 27 with a terminal 307 provided between them.

By repeating electrification and non-electrification of the electromagnetic coil 308, opening and closing of the intake valve element 301 is controlled. The electromagnetic intake valve 30 is a variable control mechanism that controls a flow rate of fuel by opening and closing the intake valve element 301. When the electromagnetic coil 308 is not electrified, an energizing force of the anchor spring 303 is transmitted to the intake valve element 301 through the anchor 305 and an anchor rod 302 that is formed integrally with the anchor 305.

The valve spring 304 is provided in a manner opposing an energizing force of the anchor spring 303. The valve spring 304 is installed on an inner side of the intake valve element 301. An energizing force of the anchor spring 303 and an energizing force of the valve spring 304 are set as described above. As a result, the intake valve element 301 is energized in a valve opening direction, and the intake opening 30d is in an open state. At this time, the anchor rod 302 and the intake valve element 301 are in contact with each other at a portion 302b (the state shown in FIG. 1).

A magnetic energizing force generated by electrification of the electromagnetic coil 308 is set to a force that allows the anchor 305 to be sucked to a stator 306 side by overcoming an energizing force of the anchor spring 303.

When the electromagnetic coil 308 is electrified, the anchor 305 moves to the stator 306 side (the left side in the diagram), and a stopper 302a formed in an end portion of the anchor rod 302 abuts on and is locked by the anchor rod bearing 309. A clearance is set so that an amount of movement of the anchor 305 is larger than an amount of movement of the intake valve element 301.

For this reason, in a state where the stopper 302a abuts on the anchor rod bearing 309, a contact portion 302b between the anchor rod 302 and the intake valve element 301 is opened. As a result, the intake valve element 301 is energized to a valve closing state by the valve spring 304, and the intake opening 30d is in a closed state.

An intake valve seat member 310 is provided in the electromagnetic intake valve 30, so as to allow the intake valve element 301 to block the intake opening 30d leading to the pressurizing chamber 11. An intake valve seat 310a is formed on the intake valve seat member 310. The intake valve seat member 310 is inserted into a tubular boss section 1b in an airtight manner, and fixed to the pump main body 1A. When the electromagnetic intake valve 30 is attached to the pump main body 1A, the intake port 30a and the intake path 10d are connected.

The discharge valve mechanism 8 includes the discharge valve seat surface 8a provided in the pump main body 1A, the discharge valve member 8b provided with a bearing 8e at a center so as to be able to maintain a reciprocating sliding movement, and the discharge valve guide member 8d provided with a center shaft 8f that is slidable with respect to a bearing of the discharge valve member 8b.

The discharge valve member 8b forms an annular contact surface 8f that can maintain oil-tightness by being in contact with the discharge valve seat surface 8a.

The discharge valve spring 8c is provided to energize the discharge valve member 8b in a valve closing direction. By the above configuration, inclination of the discharge valve member 8b can be restricted, and the discharge valve member 8b can be restrained in an axially slidable manner. Accordingly, a seat section (the discharge valve seat surface 8a) can be ensured to abut on the discharge valve member 8b. By sealing the discharge valve guide member 8d in the pump main body 1A by pressing fitting or the like, the discharge valve mechanism 8 is configured. The discharge valve mechanism 8 functions as a check valve that limits a fuel circulation direction.

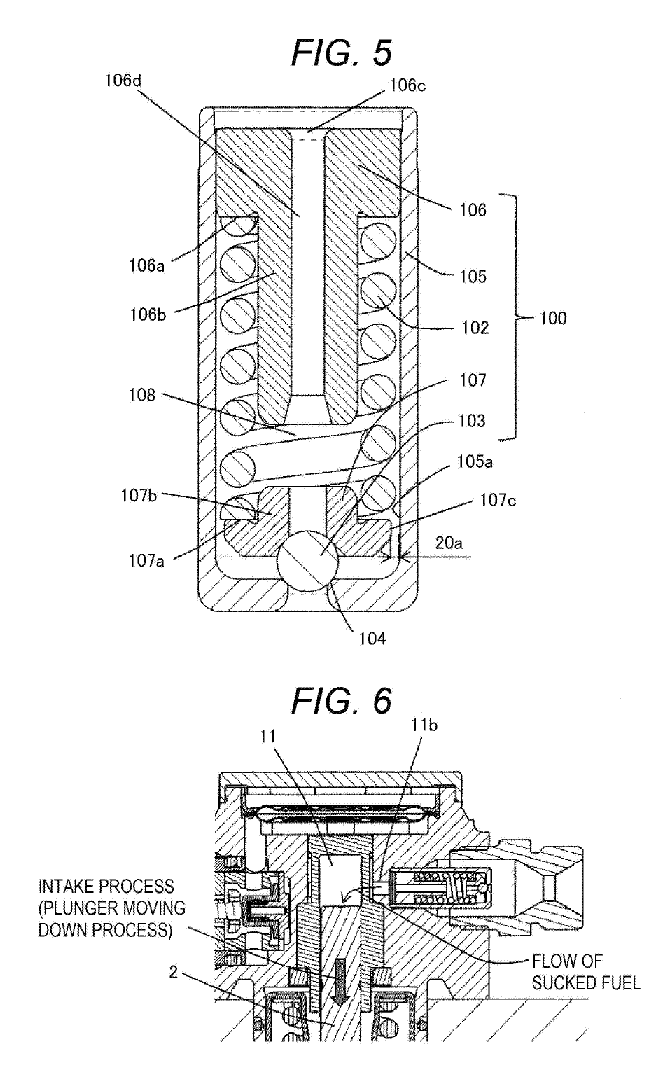

Next, a configuration and operation of the relief valve mechanism 100 will be described with reference to FIGS. 5 and 6. The relief valve mechanism 100 is contained in a containing hole (containing recess) 1C formed on the pump main body 1A. The containing hole 1C communicates with the pressurizing chamber 11 through the communication hole 11b. That is, the relief path (return path) 101 communicates with the pressurizing chamber 11 via the relief valve mechanism 100 through the communication hole 11b.

The relief valve mechanism 100 consists of a relief valve housing 105 integral with the relief valve seat 104, the relief valve 103, a relief valve holder 107, the relief spring 102, and a relief spring holder 106. A fuel path for returning from the relief chamber 108 in which the relief spring 102 is disposed to the pressurizing chamber 11 is formed in the relief spring holder 106.

The relief valve mechanism 100 is assembled as a sub-assembly outside the high-pressure pump 1. The relief valve 103, the relief valve holder 107, and the relief spring 102 are inserted sequentially into the relief valve housing 105 in this order, and the relief spring holder 106 is press-fit and fixed to the relief valve housing 105. A set load of the relief spring 102 is determined by a fixed position of the relief spring holder 106. A valve opening pressure of the relief valve 103 is determined by the set load of the relief spring 102.

The fuel supply pump of the present embodiment includes the pressurizing chamber 11 for pressurizing fuel and the relief valve mechanism 100 that returns fuel in a discharge path on a downstream side of the discharge valve 8 to the pressurizing chamber 11. The relief valve mechanism 100 includes the relief valve seat 104 that closes the relief channel when the relief valve 103 is seated, the relief spring 102 that energizes the relief valve 103 toward the relief valve seat 104, and the relief spring holder 106 that holds the relief spring 102. In the relief spring holder 106, a throttle section is formed in a fuel path for returning from the relief chamber 108 in which the relief spring 102 is disposed to the pressurizing chamber 11 and a channel.

At this time, in the relief valve that returns fuel to the pressurizing chamber 11, fuel flows into the relief valve mechanism 100 during a pressurizing process (at the time the plunger moves up) since the relief valve mechanism 100 communicates with the pressurizing chamber 11. Since a flow of fuel sucked into the pressurizing chamber 11 from the relief valve 103 is generated in an intake process (at the time the plunger moves down), a flow rate is increased at a gap section 20a between the housing 105 and a valve element presser having a small gap and the relief valve seat 104 in the vicinity of the gap section 20a, and pressure in the vicinity of the gap section 20a is lowered, leading to generation of cavitation and damage to the relief valve seat 104 by erosion, as a result, a fuel sealing function of the relief valve seat 104 may be lowered.

In view of the above, a throttle is provided in the relief spring holder 106 as in the present embodiment to restrict lowering of pressure and generation of cavitation in the vicinity of a seat, so that a high-pressure fuel supply pump with high reliability can be provided. A plurality of throttle sections may be provided in the relief valve mechanism 100. The throttle section of the present embodiment will be described in detail later.

The relief valve holder 107 is energized by the relief spring 102 to play a role of holding the relief valve 103, and a throttle section 107c is formed on an outer peripheral side of the relief valve holder 107. With the relief valve holder side throttle section 107c at the relief valve 103, the relief valve holder 107 is slidable supported. With the relief valve holder side throttle section 107c, pressure of fuel that flows in from the relief valve 103 can be lowered after passing.

The relief valve mechanism 100 includes a relief valve housing 105 that holds an outer peripheral section of the relief valve holder 107, and the relief valve holder side throttle section 107c formed on an outer peripheral side of the relief valve holder 107 is formed between an outer peripheral section of the relief valve holder 107 and an inner peripheral section of the relief valve housing 105.

The relief spring holder 106 of the relief valve mechanism 100 includes a relief spring receiving section 106a that receives the relief spring 102 on an outer peripheral side, and a projection section 106b that projects to the relief valve holder 107 side with respect to the relief spring receiving section 106a and is disposed on an inner peripheral side of a relief spring. A relief spring holder side throttle section 106d of the relief spring holder 106 is formed on an inner peripheral side of the projection section 106b. The projection section 106b of the relief spring holder 106 plays a role of holding the relief spring 102, and can prevent deformation and deterioration of the relief spring 102. When the plunger 2 moves down and fuel returns to a pressurizing chamber, the relief spring holder side throttle section 106d throttles fuel at the throttle section 106d formed on an inner peripheral side of the projection section 106b, and cavitation erosion of the relief valve seat 104 can be restricted. With the relief spring holder side throttle section 106d provided on an inner peripheral side of the projection section 106b, an advantageous effect is obtained also for reduction in a dead volume.

The relief spring holder 106 includes the relief spring receiving section 106a that receives the relief spring 102 on an outer peripheral side, and the projection section 106b that projects to the relief valve 103 side with respect to the relief spring receiving section 106a and is disposed on an inner peripheral side of the relief spring 102. The relief valve holder 107 includes a projection section 107b that projects to the relief spring holder 106 side with respect to the relief valve 103 and is disposed on an inner peripheral side of the relief spring 102. An axial length of the projection section 106b of the relief spring holder 106 is longer than an axial length of the projection section 107b of the relief valve holder 107.

The throttle section 106d formed with respect to the relief spring holder 106 is configured to have a pressure loss that is almost equivalent to or larger than that of the throttle section 107c formed with respect to the relief valve holder 107. By the above configuration, a fuel flow rate on the relief spring holder 106 side is configured to be higher. As a result, a fuel flow rate becomes lower at the throttle section provided on the relief valve holder 107 side. Accordingly, generation of cavitation erosion on the relief valve seat 104 can be restricted.

The relief spring holder side throttle section 106d formed with respect to the relief spring holder 106 is configured to be longer than the relief valve holder side throttle section 107c formed with respect to the relief valve holder. It is known that, in general, as the length is longer, a pressure loss is increased, and a throttling effect is shown more significantly. By such a configuration, when flow of fuel sucked into the pressurizing chamber 11 from the communication hole 11b of the relief path (return path) 101 is generated during an intake process (when a plunger moves down) at the time of normal operation of the high-pressure fuel supply pump shown in FIG. 6, a throttling effect is obtained at a through-hole 106c, and generation of cavitation caused by lowering of pressure in the throttle section 107c of the relief valve holder 107 and the relief valve seat section 104 in the vicinity of the throttle section 107c can be restricted.

The relief spring holder 106 side throttle section formed on the relief spring holder 106 is configured to have a cross section of 2 mm² or smaller with respect to an axial direction. As described above, the relief spring holder side throttle section 106d needs to have a stronger effect of throttling fuel than that of the relief valve holder side throttle section 107c in order to restrict cavitation erosion of the relief valve seat 104.

An axial cross section of the relief spring holder side throttle section 106d is an index of a throttling effect. In the present embodiment, an axial cross section of the relief spring holder 106 is preferably 2 mm² or smaller in order to sufficiently increase a fuel flow rate.

The relief valve mechanism 100 includes the relief valve holder 107 that is energized by the relief spring 102 and holds the relief valve 103. In the space of the relief chamber 108 formed between an end surface on the pressurizing chamber 11 side of the relief spring holder 106 and the relief valve seat 104, a volume occupied by the relief spring holder 106, the relief spring 102, the relief valve holder 107, and the relief valve 103 is configured to be larger than a volume of the other spaces. By the above configuration, reduction in a dead volume in the relief valve 103 can be expected, and efficiency of fuel discharge by a high-pressure fuel supply pump can be improved.

According to the first embodiment having the above configuration, generation of cavitation erosion on the relief valve seat 104 can be prevented also at the time a plunger moves down, lowering of a fuel seal function of the relief valve 103 can be restricted, and a highly-reliable high-pressure fuel supply pump can be provided. However, although the present embodiment has been described with reference to the accompanying drawings, shapes and the like of a relief valve structure and a throttle section are not limited to those illustrated.

### Second Embodiment

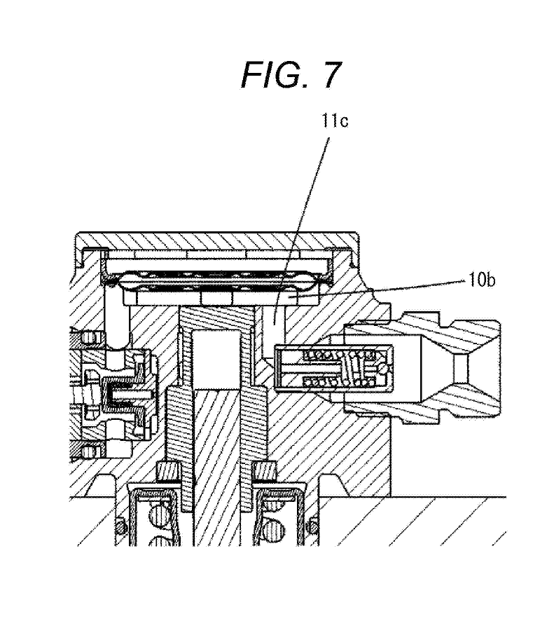

In a high-pressure fuel supply pump shown in FIG. 7, the relief path (return path) 101 communicates with the low-pressure fuel chamber 10b through the relief valve mechanism 100 by a communication hole 11c. In the present embodiment, the relief valve mechanism 100 is configured to return fuel in a discharge path on a downstream side of a discharge vale directly to a low-pressure chamber.

The unitized relief valve mechanism 100 is fixed by press-fitting the relief valve housing 105 to an inner peripheral wall of the containing hole (tubular through-hole) 1C provided on the pump main body 1A. Then, a discharge joint 12a that forms the fuel discharge opening 12 is fixed to block the containing hole 1C of the pump main body 1A, so as to prevent fuel from leaking to the outside from the high-pressure pump 1 and, at the same time, enable connection with the common rail 23.

The containing hole 1C and a containing hole 1D are connected by the discharge path 110 as shown in FIG. 3.

In this manner, the discharge path 110 communicates with the fuel discharge opening 12 through the containing hole 1C.

When capacity of the pressurizing chamber 11 starts to decrease by movement of the plunger 2, pressure in the pressurizing chamber 11 increases along with the decrease in the capacity. When pressure in the pressurizing chamber 11 becomes higher than pressure in the discharge path 110, the discharge valve mechanism 8 is opened, and fuel is discharged from the pressurizing chamber 11 to the discharge path 110. From the instant the discharge valve mechanism 8 is opened to immediately after, pressure in the pressurizing chamber 11 overshoots and becomes an extremely high pressure. This high pressure also propagates to the inside of the discharge path 110, pressure in the discharge path 110 also overshoots at the same timing.

If, at this time, an exit of the relief valve mechanism 100 is connected to the intake path 10d, the pressure overshoot in the discharge path 110 causes a pressure difference between an entrance and an exit of the relief valve 103 becomes higher than a valve opening pressure of the relief valve mechanism 100, and the relief valve 103 may erroneously operate.

In contrast, in the present embodiment, an exit of the relief valve mechanism 100 is connected to the pressurizing chamber 11. Accordingly, pressure in the pressurizing chamber acts on the exit of the relief valve mechanism 100, and pressure in the discharge path 110 acts on an entrance of the relief valve mechanism 100. Overshoot of pressure occurs at the same timing in the pressurizing chamber 11 and the discharge path 110. Accordingly, a pressure difference between an entrance and an exit of the relief valve 103 never becomes a valve opening pressure of the relief valve 103 or higher. That is, the relief valve 103 never erroneously operates.

When capacity of the pressurizing chamber 11 starts to increase by movement of the plunger 2, pressure in the pressurizing chamber 11 decreases as the capacity increases, and becomes lower than pressure in the intake path 10d (intake port 30a). In this state, fuel flows into the pressurizing chamber 11 from the intake path 10d (intake port 30a). When capacity of the pressurizing chamber 11 starts to decrease due to movement of the plunger 2 again, fuel is pressurized to a high pressure and discharged by the above mechanism. Even when this structure is used, improvement in discharge efficiency can be expected.

Next, a case where an abnormally high pressure is generated in the common rail 23 and the like due to a failure and the like of the direct injection injector 24 will be described in detail.

If an injection function of the direct injection injector 24 stops and fuel sent to the common rail 23 cannot be supplied to a combustion chamber of an internal combustion engine any more, fuel is accumulated between the discharge valve mechanism and the common rail 23, and a fuel pressure becomes an abnormally high pressure. In this case, when pressure increases gradually, an abnormality is detected by the pressure sensor 26 provided in the common rail 23, and a safety function for reducing a discharge amount by feedback-controlling the electromagnetic intake valve 30, which is a capacity control mechanism provided in the intake path 10d (intake port 30a), operates. However, an instant abnormally high pressure cannot be handled by feedback control using the pressure sensor 26.

When the electromagnetic intake valve 30 fails and the common rail 23 no longer functions in a mode at the time of maximum capacity, a discharge pressure becomes abnormally high in an operation state in which a large amount of fuel is not required. In this case, even when the pressure sensor 26 of the common rail 23 detects an abnormally high pressure, this abnormally high pressure cannot be eliminated since the capacity control mechanism itself fails. When such an abnormally high pressure occurs, the relief valve mechanism 100 of the present embodiment functions as a safety valve.

When capacity of the pressurizing chamber 11 starts to increase by movement of the plunger 2, pressure in the pressurizing chamber 11 decreases along with the increase in the capacity. At this time, when a pressure of an entrance of the relief valve mechanism 100, that is, the discharge path 110, becomes higher than a pressure of an exit of the relief valve 103, that is, the pressurizing chamber 11 by a valve opening pressure of the relief valve mechanism 100 or higher, the relief valve mechanism 100 is opened. As the relief valve mechanism 100 is opened, fuel at an abnormally high pressure in the common rail 23 is returned to the pressurizing chamber 11. In this manner, a high-pressure pipe system, such as the common rail 23, does not have a specified pressure or higher even when an abnormally high pressure is generated, and the high-pressure pipe system, such as the common rail 23, is protected.

That is all for the description. The present invention is not limited to the above embodiments and includes a variety of variations. The above embodiments are described in detail for easy understanding of the present invention, and the present invention is not necessarily limited to embodiments that include all the configurations. A configuration of a certain embodiment can be replaced with a configuration of another embodiment, and a configuration of a certain embodiment can be added to a configuration of another embodiment. For part of a configuration of an embodiment, other configurations may be added, removed, or replaced.

### REFERENCE SIGNS LIST

1A Pump main body
2 Plunger
6 Cylinder
8 Discharge valve mechanism
9 Pressure pulsation reduction mechanism
10d Intake path
11 Pressurizing chamber
23 Common rail
26 Pressure sensor
30 Electromagnetic intake valve
30a Intake port
100 Relief valve mechanism
103 Relief valve
104 Relief valve seat
106 Relief spring holder
106a Relief spring receiving section
106b Relief spring side projection section
106c Relief spring side through-hole
106d Relief spring side throttle section
107 Relief valve holder
108 Relief chamber
110 Discharge path

1. A fuel supply pump comprising:
a pressurizing chamber configured to pressurize fuel; and
a relief valve mechanism configured to return fuel in a discharge path on a downstream side of a discharge valve to the pressurizing chamber, wherein
the relief valve mechanism comprises:
a relief seat configured to close a relief channel when a relief valve is seated;
a relief spring configured to energize the relief valve to the relief seat; and
a relief spring holder configured to hold the relief spring, and
in the relief spring holder, a relief spring holder side throttle section is formed in a fuel path for returning from a relief chamber in which the relief spring is disposed to the pressurizing chamber and the channel.

2. The fuel supply pump according to claim 1, further comprising a relief valve holder configured to be energized by the relief spring and hold the relief valve, wherein
a relief valve holder side throttle section is formed on an outer peripheral side of the relief valve holder.

3. The fuel supply pump according to claim 1, further comprising a relief valve housing configured to hold an outer peripheral section of the relief valve holder, wherein
a relief valve holder side throttle section formed on an outer peripheral side of the relief valve holder is formed between the outer peripheral section of the relief valve holder and an inner peripheral section of the relief valve housing.

4. The fuel supply pump according to claim 1, wherein
the relief spring holder comprises:
a relief spring receiving section configured to receive the relief spring on an outer peripheral side; and
a relief spring holder side projection section configured to project to the relief valve side with respect to the relief spring receiving section and be disposed on an inner peripheral side of the relief spring, and
a relief spring holder side throttle section of the relief spring holder is formed on an inner peripheral side of the relief spring holder side projection section.

5. The fuel supply pump according claim 2, wherein
the relief spring holder comprises:
a relief spring receiving section configured to receive the relief spring on an outer peripheral side; and
a relief spring holder side projection section configured to project to a relief valve side with respect to the relief spring receiving section and is disposed on an inner peripheral side of the relief spring, wherein
the relief valve holder comprises a relief valve holder side projecting section configured to project to the relief spring holder side with respect to the relief valve and is disposed on an inner peripheral side of the relief spring, and
an axial length of the relief spring holder side projection section is longer than an axial length of the relief valve holder side projection section.

6. The fuel supply pump according to claim 2, wherein
the relief spring holder side throttle section formed with respect to the relief spring holder has an almost equal or higher pressure loss as compared to the relief valve holder side throttle section formed with respect to the relief valve holder.

7. The fuel supply pump according to claim 2, wherein
the relief spring holder side throttle section formed with respect to the relief spring holder is longer than the relief valve holder side throttle section formed with respect to the relief valve holder.

8. The fuel supply pump according to claim 1, wherein
the relief spring holder side throttle section formed with respect to the relief spring holder has a cross section of 2 mm² or smaller with respect to an axial direction.

9. The fuel supply pump according to claim 1, further comprising a relief valve holder configured to be energized by the relief spring and hold the relief valve, wherein
in space of a relief chamber formed from a pressurizing chamber side end surface of the relief spring holder to the relief valve seat, a volume occupied by the relief spring holder, the relief spring, the relief valve holder, and the relief valve is larger than a volume of the other spaces.

10. A fuel supply pump comprising:
a pressurizing chamber configured to pressurize fuel; and
a relief valve mechanism configured to return fuel in a discharge path on a downstream side of a discharge valve directly to a low-pressure chamber, wherein
the relief valve mechanism comprises:
a relief seat configured to close a relief channel when a relief valve is seated;
a relief spring configured to energize the relief valve to the relief seat; and
a relief spring holder configured to hold the relief spring, and
in the relief spring holder, a relief spring holder side throttle section is formed in a fuel path for returning from a relief chamber in which the relief spring is disposed to the low-pressure chamber and the channel.
